(19) United States
(12) Patent Application Publication
(10) Pub. No.: US 2025/0213340 A1
(43) Pub. Date: Jul. 3, 2025

(54) Sustainably Powered Personal Care Devices and Methods

(71) Applicant: Colgate-Palmolive Company, New York, NY (US)

(72) Inventor: Awassada ARIYAPHUTTARAT, Brooklyn, NY (US)

(73) Assignee: Colgate-Palmolive Company, New York, NY (US)

(21) Appl. No.: 18/992,000

(22) Filed: Dec. 23, 2024

Related U.S. Application Data
(60) Provisional application No. 63/615,173, filed on Dec. 27, 2023.

(51) Int. Cl. A61C 17/22; H01M 10/46; H01M 10/48; H01M 50/247; H02K 7/18

(52) U.S. Cl. CPC A61C 17/224; H01M 10/46; H01M 10/488; H01M 50/247; H02K 7/1823; A61C 2204/002; H01M 2220/30

(57) ABSTRACT

A powered personal care (e.g., razor, toothbrush, etc.) system may comprise a battery-powered oral care device. The oral care device may comprise a handle portion that may comprise a rechargeable battery configured to be detachably connected to the handle portion. The handle portion may comprise a motor configured to be energized by the rechargeable battery. The oral care device may comprise a head portion that may comprise a plurality of brush bristles. The personal care system may comprise a hydraulically powered battery charging device. The charging device may comprise a housing, a hydraulic inlet port, a magnetic core, a turbine blade in mechanical communication with the magnetic core. The turbine blade may be motivated into rotation by a flow of hydraulic fluid across the at least one turbine blade. The charging device may comprise a battery port configured to insertably receive the rechargeable battery.

### CROSS-REFERENCE TO RELATED APPLICATIONS

The present application claims the benefit of priority to U.S. Provisional Patent Application Ser. No. 63/615,173, filed Dec. 27, 2023, the entirety of which is incorporated herein by reference.

### BACKGROUND

A personal care device, such as a toothbrush, razor, water pick, etc., may be used to clean the one or more body parts (e.g., teeth/dentition) in an target area (e.g., oral cavity, legs, arm pits, etc.), for example by removing plaque and/or debris from the tooth/dentition surfaces. Toothbrushes may also emit light for purposes such as, for example, whitening teeth, killing bacteria within the oral cavity/mouth, detecting the presence of bacteria within the mouth, increasing blood circulation for gum therapy, and/or reducing the pain from gum inflammation.

Powered toothbrushes may offer enhanced cleaning capabilities perhaps in contrast to manually operated toothbrushes. Powered toothbrushes may include an electric motor that may provide the excitation energy to a toothbrush head, perhaps so that bristles that may be part of the toothbrush head can be motivated for a more dynamic tooth/dentition cleaning effect. Powered toothbrushes may include a rechargeable battery to energize the motor.

### BRIEF SUMMARY

The present disclosure may describe one or more powered personal care (e.g., razor, toothbrush, water pick, etc.) devices, systems, and/or methods, processes, and/or techniques performed by, and/or using, the one or more devices. A powered personal care system may comprise a battery-powered oral care device may comprise a handle portion. The handle portion may comprise a rechargeable battery. The rechargeable battery may be configured to be detachably connected to the handle portion. The handle portion may comprise a motor. The motor may be configured to be energized by the rechargeable battery. The oral care device may comprise a head portion. The head portion may comprise a plurality of brush bristles.

The powered personal care system may comprise a hydraulically powered battery charging device. The charging device may comprise a housing. The housing may comprise a top surface and a bottom surface. The charging device may comprise a hydraulic inlet port that may be disposed in the top surface and/or the bottom surface. The inlet port may be configured to be connected to a hydraulic fluid source. The charging device may comprise a magnetic core that may be disposed within the housing.

The charging device may comprise at least one turbine blade in mechanical communication with the magnetic core such that a rotation of the at least one turbine blade may cause a rotation of the magnetic core. The at least one turbine may be configured to be motivated into rotation by a flow of the hydraulic fluid across the at least one turbine blade. The charging device may comprise a battery port that may be configured to insertably receive the rechargeable battery.

In one or more scenarios, the inlet port may be configured to be connected to a water supply line in a residential bathroom shower hydraulic circuit, and/or other residential fluid supply sources such as bathroom/restroom sinks, kitchen sinks, and/or other residential water sources.

In one or more scenarios, a process may be implemented using the powered personal care system. The process may comprise detaching the rechargeable battery from the handle portion. The process may comprise inserting the rechargeable battery into the battery port. The process may comprise activating the residential bathroom shower hydraulic circuit. The process may comprise charging the rechargeable battery. The process may comprise removing the rechargeable battery from the battery port. The process may comprise attaching the rechargeable battery to the handle portion.

In one or more scenarios, the process may comprise deactivating the residential bathroom shower hydraulic circuit after charging the rechargeable battery. In one or more scenarios, the process may comprise deactivating the residential bathroom shower hydraulic circuit prior to removing the rechargeable battery from the battery port. In one or more scenarios, the process may comprise activating the oral care device after attaching the rechargeable battery to the handle portion.

### BRIEF DESCRIPTION OF THE DRAWINGS

The present disclosure will become more fully understood from the detailed description and the accompanying drawings, wherein:

FIG. 1 illustrates an example diagram of a powered personal care device with a detachable rechargeable battery.

FIG. 2 illustrates an example component diagram of powered personal care devices with a detachable rechargeable battery.

FIG. 3 is an example flow diagram of at least one technique performed by/with a powered personal care system.

FIG. 4 is a block diagram of a hardware configuration of an example device that may control one or more elements/devices of a powered personal care system.

FIG. 5 are illustrations of front and rear views of an example charging device with an inserted rechargeable battery.

FIG. 6 illustrates an example component diagram of a charging device.

FIG. 7 illustrates an example internal diagram of a charging device with an inserted rechargeable battery.

FIG. 8 illustrates an example diagram of a charging device installed in a residential hydraulic circuit environment.

FIG. 9 illustrates example diagrams of water blade turbines that may be used with the charging device.

The drawings represent one or more aspects of the disclosure and do not limit the scope of invention.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to the interpretation “based entirely on.”

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

In the following description, where block diagrams or circuits are shown and described, one of skill in the art will recognize that, for the sake of clarity, not all peripheral components or circuits are shown in the figures or described in the description. For example, common components such as memory devices and power sources may not be discussed herein, as their role would be easily understood by those of ordinary skill in the art. Further, the terms “couple” and “operably couple” can refer to a direct or indirect coupling of two components of a circuit.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi™, Bluetooth™, LAN, cellular, satellite, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain scenarios, the any of the subject matter disclosed herein may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

As used herein, a “sensor” may refer to any instrument configured to enable the capturing of data for a parameter related to the powered personal care (e.g., razor, toothbrush, water pick, etc.) device. Further, “data” or “sensor data” may refer to any type of data obtained from a sensor or based on data obtained from a sensor. Such data includes but is not limited to information extracted or derived from a sensor or sensor signal, or from an image-capturing device such as a camera, regardless of the form of the extracted information, and/or combinations thereof. Such data may be, for example, in the form of mathematical data (such as a formula which mathematically represents at least part of the sensor signal), analog data (such as the waveform of the sensor signal), and/or digital data (such as a representation of at least part of the sensor signal in a digital format). The data may include statistical features derived from the sensor signal. The data may include measurements such as intervals between sensor signals, duration of time over which sensor signals are captured, the time of day, calendar date, geographic location, etc., in which the sensor signals are captured and/or the timing of sensor signals in relation to a user's use of the powered personal care (e.g., razor, toothbrush, water pick, etc.) device. Different data features may be useful for assessing different health conditions and/or measuring different types of personal care (e.g., razor, toothbrush, water pick, etc.) behavior. Specific combinations of data/data features may be uniquely informative for a given behavior and/or health condition.

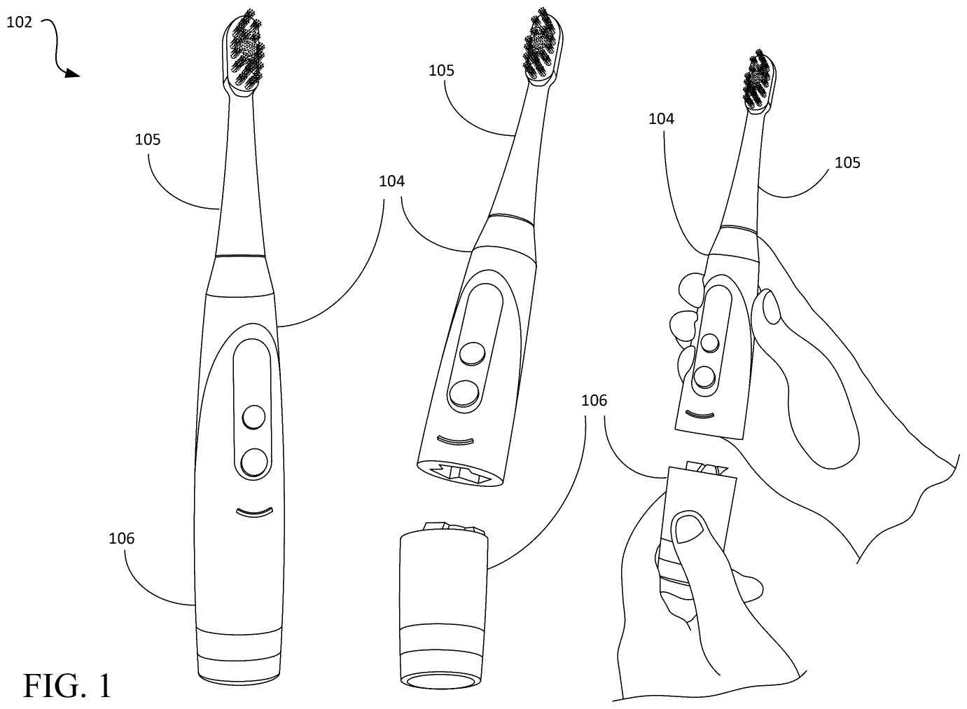

FIG. 1 illustrates an example diagram of a powered personal care device (e.g., a motorized toothbrush) 102 with a handle portion 104, a detachable/replaceable head portion 105, and/or a detachable/replaceable rechargeable battery 106. In one or more scenarios, the powered personal care device 102 may be at least one of other types of personal care devices, such as a razor, a water pick, among others, etc.

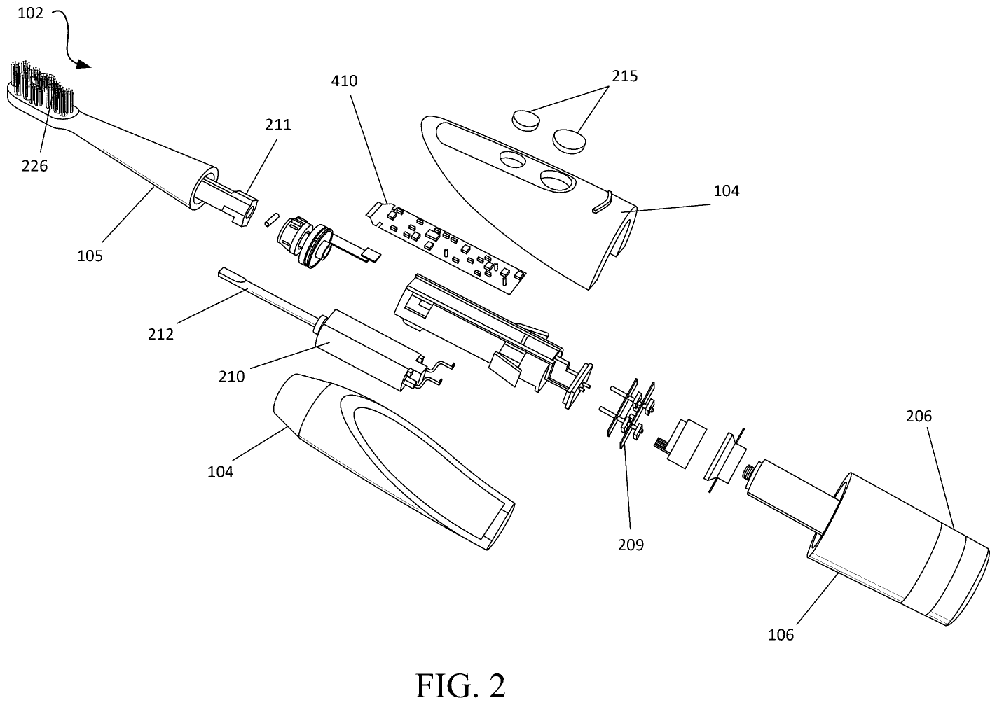

FIG. 2 illustrates an example component diagram of powered personal care device 102 with a detachable rechargeable battery 106. At 209, a battery coil may be provided. At 211, one or more gears may be provided. At 215, one or more on/off and/or speed buttons may be provided.

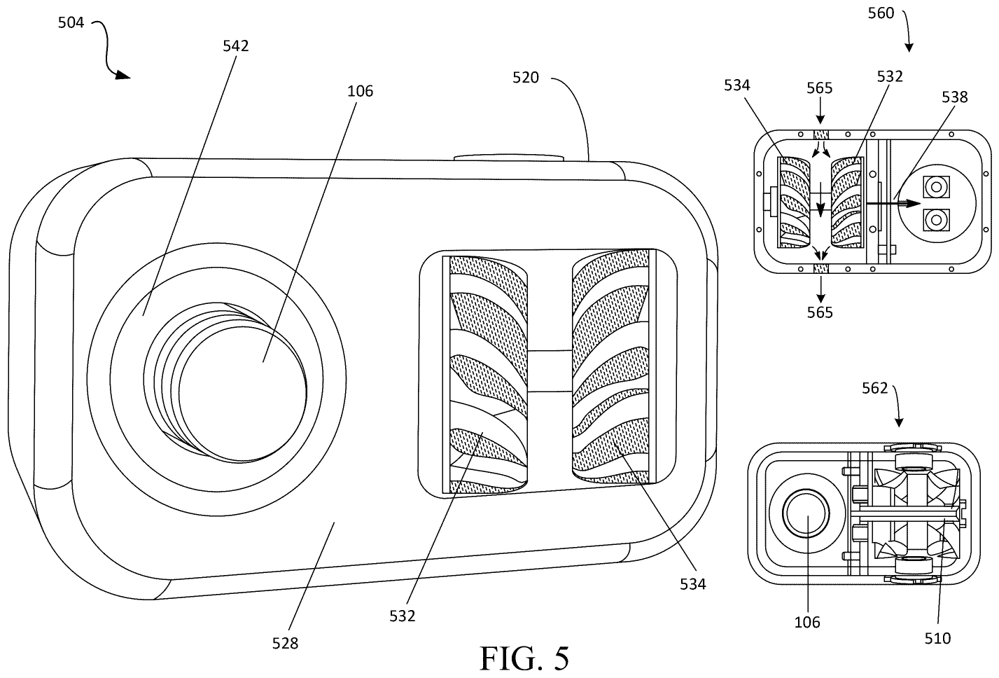

FIG. 5 are illustrations of front and rear views 502 of an example charging device 504 with an inserted rechargeable battery 106.

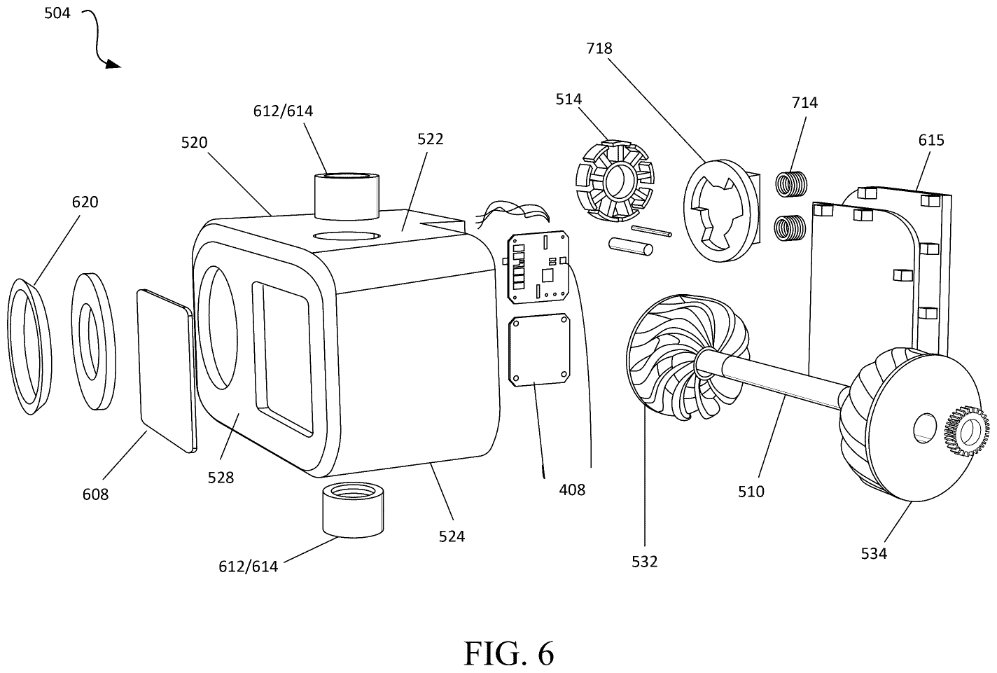

FIG. 6 illustrates an example component diagram of a charging device 504.

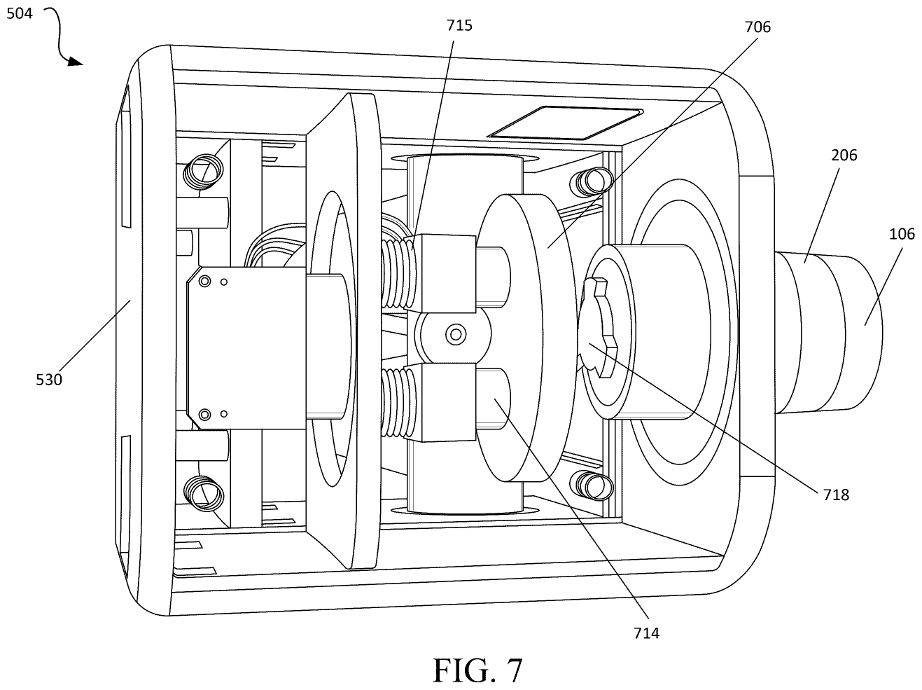

FIG. 7 illustrates an example internal diagram of a charging device 504 with an inserted rechargeable battery 106. At 706, electromagnetic induction coil may be provided. At 530, a rear surface may be provided. At 718, a female lock fitting may be provided. At 714, a push lock/release mechanism may be provided. A push spring 715 (of 714) may be provided. At 106, a hydropower rechargeable battery may be provided. At 206, a battery indicator light may be provided.

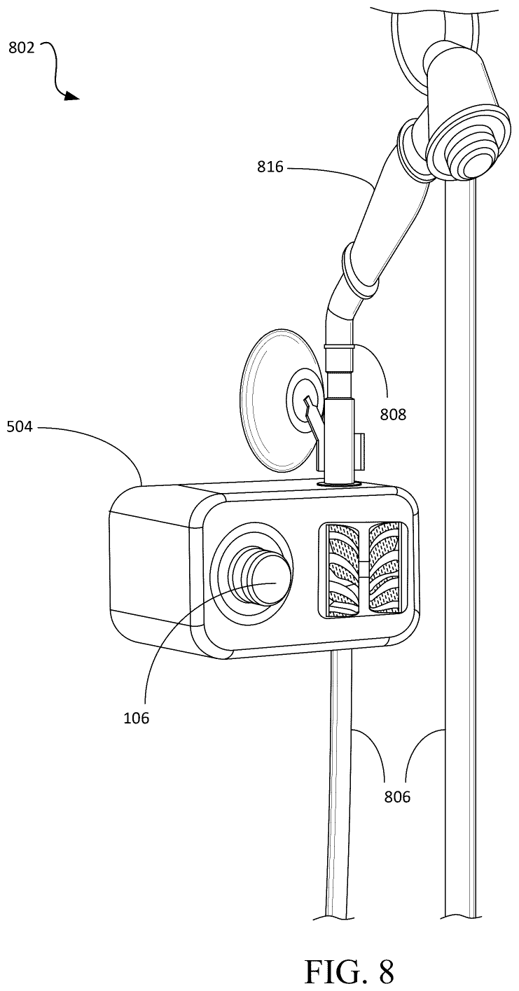

FIG. 8 illustrates an example diagram of a charging device 504 installed in a residential hydraulic circuit 806.

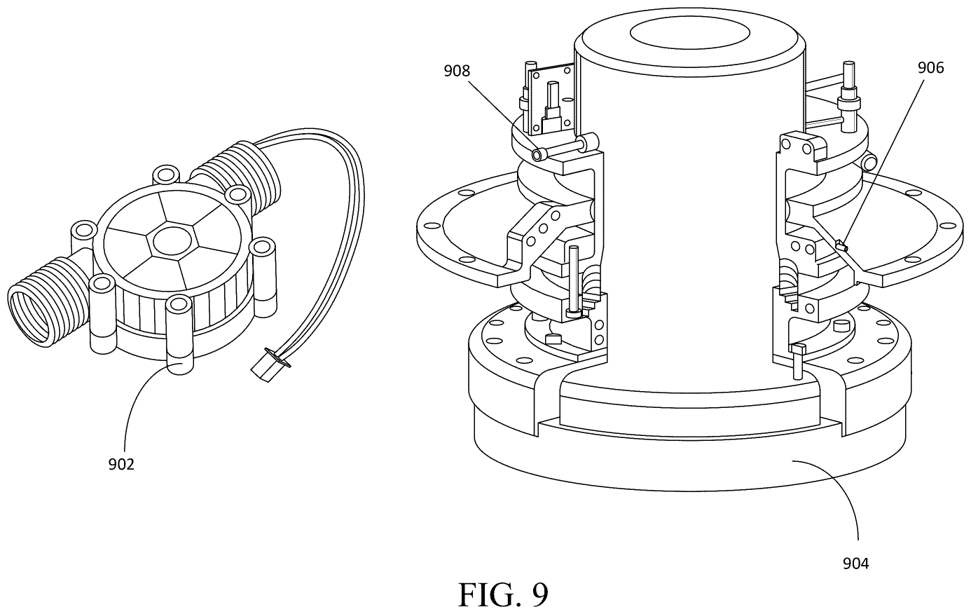

FIG. 9 illustrates example diagrams of water blade turbine 902 and water blade turbine 904 that may be used with the charging device 504. In one or more scenarios, the charging device 504 may be configured to use water blade turbine 902 and/or water blade turbine 904, among other water blade turbines (not shown) as the ordinarily skilled artisan may deem useful. At 906, a cooling-water connection may be provided and/or that may be blanked if not used, for example. At 908, magnetic feed mechanism may be provided with, for example with 3/8 NPT connections, among other kinds/types/sizes of connections.

Referring to FIG. 1 to FIG. 9, in one or more scenarios, a powered personal care system may comprise a battery-powered oral care device 102. The oral care device 102 may comprise a handle portion 104. The handle portion may comprise a rechargeable battery 106. The rechargeable battery 106 may be configured to be replaceably/detachably connected to the handle portion 104. The handle portion may comprise a motor 210. The motor 210 may be configured to be energized by the rechargeable battery 106. The oral care device 102 may comprise a head portion 105. The head portion 105 may comprise a plurality of brush bristles 226.

The powered personal care system may comprise a hydraulically powered battery charging device 504. The charging device 504 may comprise a housing 520. The housing 520 may comprise a top surface 522 and/or a bottom surface 524. The charging device 504 may comprise a hydraulic inlet port 612 that may be disposed in the top surface 512 and/or the bottom surface 524. The hydraulic inlet port 612 may be configured to be connected to a hydraulic fluid source 806. At 615, one or more back lids may be provided. At 620, one or more cap linings may be provided.

The charging device 504 may comprise a magnetic core 510 that may be disposed within the housing 520. At 560, a cut away rear view of hydropower charging device 504 is illustrated. At least one turbine blade 532 may be in mechanical communication with the magnetic core 510 such that a rotation of the at least one turbine blade 532 may cause a rotation of the magnetic core 510. The at least one turbine blade 532 may be configured to be motivated into rotation by a flow of the hydraulic fluid 565 (e.g., water, among other fluids) (not shown) the at least one turbine blade 532. Although the water/hydraulic fluid is shown flowing from in a particular direction in FIG. 5, the water/hydraulic fluid may also flow in the opposite direction for proper charging device 504 operation. At 562, a cut away front view of hydropower charging device 504 is illustrated. The charging device may comprise a battery port 542 that may be configured to (e.g., insertably) receive the rechargeable battery 106.

In one or more scenarios, the at least one turbine blade 532 may be a first turbine blade 532. The charging device 504 may comprise a second turbine blade 534. The second turbine blade 534 may be disposed opposite the first turbine blade 532. The second turbine blade 534 may be in mechanical communication with the magnetic core 510 such that a rotation of the second turbine blade 534 may cause a rotation of the magnetic core 510. The second turbine blade 534 may be configured to be motivated into rotation by the flow of the hydraulic fluid (e.g., water, among other fluids) (not shown) across the second turbine blade 534. The rotation of the magnetic core 510 may create a magnetic field (not shown). In FIG. 5, the magnetic field may extend at least in the direction of indicator 538.

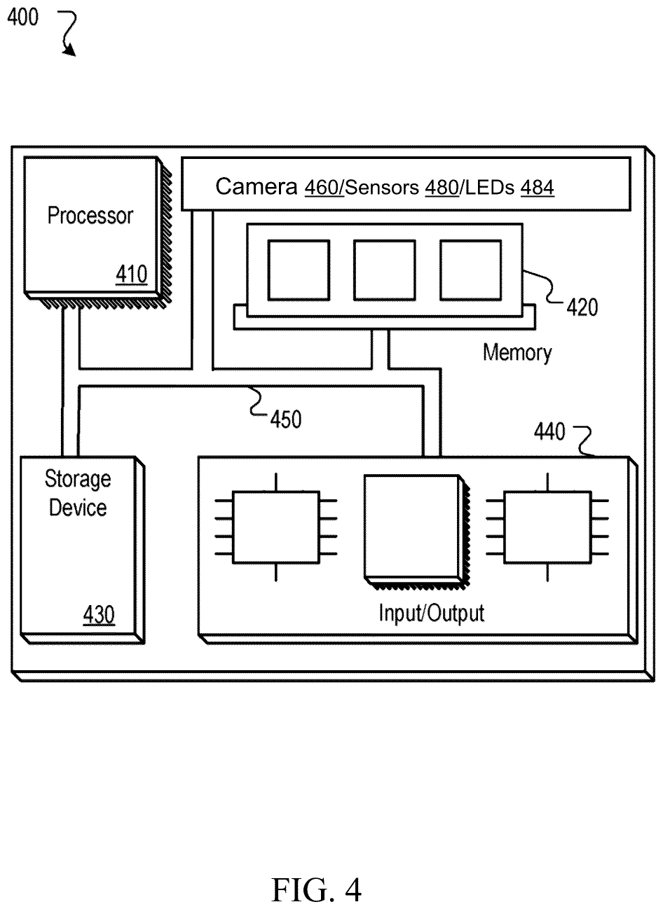

In one or more scenarios, the charging device 504 may comprise a charging printed circuit board (PCB) 408 that may be disposed in the housing 520. The charging PCB 408 may be configured to convert the magnetic field into a current (not shown). In one or more scenarios, the charging PCB 408 may be the same/substantially similar to the hardware configuration 400 of FIG. 4.

In one or more scenarios, the charging device 540 may comprise an electromagnetic induction coil 706 that may be configured to convert the current into a magnetic charging field (not shown). The magnetic charging field may be configured to magnetically charge the rechargeable battery 106 in the battery port 542. In one or more scenarios, the charging device 504 may be configured to electrically charge the rechargeable battery 106 via the current.

In one or more scenarios, the charging device 504 may comprise a hydraulic outlet port 614 that may be disposed opposite the hydraulic inlet port 612 in the top surface 522 and/or the bottom surface 524. The hydraulic outlet port 614 may be configured to be connected to a hydraulic discharge channel 808. As the hydraulic inlet port 612 and/or the hydraulic outlet port 614 may be orientated on either the top surface 522 and/or the bottom surface 524, the charging device 504 may effectively operate in numerous orientations (e.g., top surface 522 up, bottom surface 528 up, either surface 522 and/or 528 sideways, either surface 522 and/or 528 on some form of diagonal, etc.). In this way the charging device 504 may accommodate numerous residential hydraulic circuits/water piping schemes.

In one or more scenarios, the charging device 504 may be configured such that the hydraulic inlet port 612 may be connected to a water supply line 806 in a residential bathroom shower hydraulic circuit/piping scheme, and/or other residential fluid supply sources such as bathroom/restroom sinks, kitchen sinks, and/or other residential water sources (not shown). The hydraulic outlet port 614 may be connected to a residential bathroom shower nozzle 816.

In one or more scenarios, the charging device 504 may be configured such that an activation of the residential bathroom shower hydraulic circuit may motivates water to flow into the hydraulic inlet port 612, across the first turbine blade 532 and/or the second turbine blade 534, and/or out of the hydraulic outlet port 614.

In or more scenarios, the charging device 504 may be configured such that the activation of the residential bathroom shower hydraulic circuit may motivate water to flow through the residential bathroom shower nozzle 816.

In one or more scenarios, the oral care device 102 may be configured such that the head portion 105 may be removably connected to the handle portion 104 in at least two states. One state may be a decoupled state in which the head portion 105 may be separated from the handle portion 104 (e.g., generally illustrated in FIG. 2). At least a second state may be a coupled state in which the head portion 105 may be connected to the handle portion 104 (e.g., generally illustrated in FIG. 1).

In one or more scenarios, the oral care device 102 may comprise a motor shaft 212. The motor 210 may be configured to provide at least some amount of oscillation energy via the motor shaft 212 to the head portion 105 in the coupled state. The oscillation energy may place the plurality of brush bristles 226 into a condition of vibrational motion and/or rotational motion. In one or more scenarios, the oscillation energy may place the head portion 105 into motion relative to the handle portion 104.

In one or more scenarios, the handle portion 104 may be friction coupled and/or threadedly connected to the head portion 105 in the coupled state. In one or more scenarios, the rechargeable battery 106 may be configured as a base of the oral care device 102.

In one or more scenarios, the oral care device 102 may comprise a brushing printed circuit board (PCB) 410 that may be disposed in the handle portion 104. The brushing PCB 410 may be configured to control one or more functions of the oral care device 102. In one or more scenarios, the brushing PCB 410 may be the same/substantially similar to the hardware configuration 400 of FIG. 4.

In one or more scenarios, the charging device 504 may comprise a magnetic wheel 514 that may be disposed in the housing 520. The magnetic wheel 514 may be in magnetic communication with the magnetic core 510. The magnetic wheel 514 may be configured such that the rotation of the magnetic core 510 may cause a rotation of the magnetic wheel 514. The charging device 504 may be configured such that an effect of the rotation of the magnetic wheel 514 on the charging (PCB) may generate the current.

In one or more scenarios, the charging device 504 may comprise a push lock/release mechanism 714 that may be disposed in the housing 520 coaxially with the battery port 542. The push lock/release mechanism 714 may be configured to secure the rechargeable battery 106 upon the rechargeable battery 106 insertion into the battery port 542 and/or to release the rechargeable battery 106 upon the rechargeable battery 106 removal from the battery port 542.

In one or more scenarios, the rechargeable battery 106 may comprise a light emitting diode (LED) indicator 206. The LED indicator 206 may be configured to indicate a charged state of the rechargeable battery 106 via a first color (e.g., green) of light emitted by the LED indicator 206. The LED indicator 206 may be configured to indicate a less-than-full charged state of the rechargeable battery via a second color (e.g., red) of light emitted by the LED indicator 206.

In one or more scenarios, the charging device 504 may be further configured such that the first turbine blade 532, the second turbine blade 534, and/or the magnetic core 510 may be disposed in a coaxial arrangement.

In one or more scenarios, the housing 520 may a front surface 528 and/or a rear surface 530 disposed opposite the front surface 528. The charging device 504 may be configured such that the battery port 542 may be disposed in the front surface 528.

In one or more scenarios, the charging device 504 may be configured such that an optical panel 608 may be disposed in the front surface 528 of the housing 520. The optical panel 608 may be configured to provide at least some visibility of at least the first turbine blade 532, the second turbine blade 534, and/or the magnetic core 510.

In one or more scenarios, the charging device 504 may be configured such that the push lock/release mechanism 714 may comprise a (e.g., female) lock fitting 718 that may be disposed proximate to a rear of the battery port 542. The lock fitting 718 may be configured to secure the rechargeable battery 106 upon the rechargeable battery 106 insertion into the battery port 542.

In one or more scenarios, the charging device 504 may be configured such that the hydraulic inlet port 612 may be threadedly connected to the hydraulic fluid source 806. The hydraulic outlet port 614 may be threadedly connected to the hydraulic discharge channel 808.

In one or more scenarios, the oral care device 102 may be configured such that the rechargeable battery 106 may be threadedly and/or releasably connected to the handle portion 104 (not shown).

One or more determinations may be made as to how much current can be generated using a flow rate of, for example, 2 gallons per minute (gpm). This flow rate may be converted into a power potential using hydropower principles. The electrical output may be determined based on the efficiency of the generating system.

The potential power (e.g., in Watts) from a hydropower source can be calculated using the formula:

$$P = η \times ρ \times g \times Q \times H$$

Where:
P=Power (in Watts)
η=Efficiency of the turbine and generator (for estimation, a combined efficiency of 70% or 0.7 may be assumed)
ρ=Density of water (approximately 1000 kg/m³ for fresh water)
g=Acceleration due to gravity (approximately 9.81 m/s²)
Q=Flow rate (in m³/s)
H=Head or height difference (in meters)

In one or more scenarios, the 2 gpm may be converted to m³/s, where 2 gpm≈0.000126 m³/s. Assuming a typical home/residential shower height for water drop (e.g., an assumed 2 meters for head pressure), using these numbers, they may be input into the formula:

$$P = 0.7 \times 1000 \times 9.81 \times 0.000126 \times 2$$

P≈1.75 watts

This may be the power potential to be used as a (e.g., general) estimation for the hydropower battery charging system.

To determine the current (I) generated, use of Ohm's Law may provide:

$$P = V \times I$$

Estimating that the charging device 504 may generate electricity at 5 volts (e.g., like a small-scale DC generator):

$$I \approx P / V = 1.75 / 5$$

I≈0.35 amperes or 350 mA (milli Amps)

Estimating that a typical/average residential shower may take 10 minutes a day (e.g., per person showering), the total power to charge the rechargeable battery may be determined as:

$$350 \times 10 / 60 = 58.3 mAH ( milli Amp Hours )$$

The oral care device 102 may use 300 mA for 4 minutes a day and the total power consumption for the oral care device may be:

$$300 \times 4 / 60 = 20 mAH$$

As such, a residential shower system/hydraulic circuit, and/or other residential fluid supply sources such as bathroom/restroom sinks, kitchen sinks, and/or other residential water sources, may be used to power the rechargeable battery 106 by the charging device 504 for use by the oral care device 102.

One or more methods may be performed by/with a powered personal care system as described herein, in which the hydraulic inlet port 612 may be connected to a water supply line in a residential bathroom shower hydraulic circuit, such as the water supply line 808 of FIG. 8, and/or other residential fluid supply sources such as bathroom/restroom sinks, kitchen sinks, and/or other residential water sources (not shown). One or more methods may comprise detaching the rechargeable battery 106 from the handle portion 104. One or more methods may comprise inserting the rechargeable battery 106 into the battery port 542.

One or more methods may comprise activating the residential bathroom shower hydraulic circuit. One or more methods may comprise charging the rechargeable battery 106 via the charging device 504. One or more methods may comprise removing the rechargeable battery 106 from the battery port 542. One or more methods may comprise attaching the rechargeable battery 106 to the handle portion 104.

In one or more scenarios, one more methods may comprise deactivating the residential bathroom shower hydraulic circuit, perhaps after charging the rechargeable battery 106. In one or more scenarios, one or more methods may comprise deactivating the residential bathroom shower hydraulic circuit, perhaps prior to removing the rechargeable battery 106 from the battery port 542.

In one or more scenarios, one or more methods may comprise activating the oral care device 102, perhaps after attaching the rechargeable battery 106 to the handle portion 104.

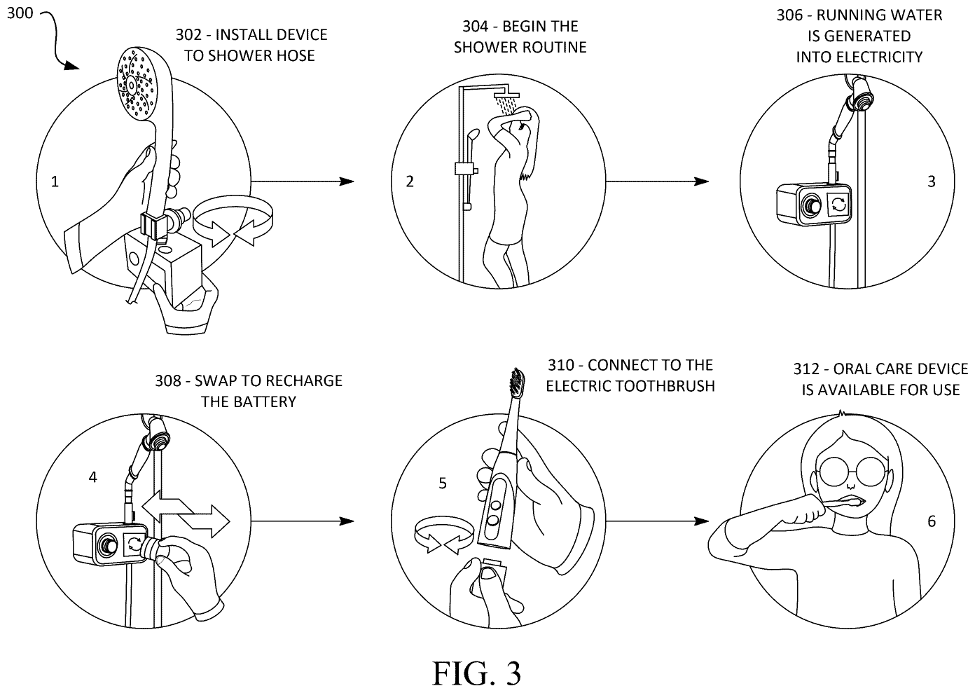

In view of FIG. 1 to FIG. 9, referring to FIG. 3, a diagram 300 illustrates an example technique that may be performed by/with a powered personal care system as described herein. At 302, techniques may comprise installing the charging device 504 to shower hose 806 and/or 808 and/or shower nozzle 816.

At 304, techniques may comprise activating the residential hydraulic/water circuit providing the water supply to 808 (e.g., a resident/user of the system may take a shower at this time to avoid wasting water, etc.). At 306, techniques may comprise charging the rechargeable battery 106 via the charging device 504 as energized with the running water from the residential hydraulic circuit.

At 308, techniques may comprise removing the rechargeable battery 106 from the charging device 504 (e.g., after the LED 206 indicates a sufficiently charged state for the rechargeable battery 106). At 310, techniques may comprise attaching the rechargeable battery 106 to the oral care device 102. At 312, techniques may comprise activating the oral care device 102 for normal use with the (e.g., sufficiently) charged rechargeable battery 106.

FIG. 4 is a block diagram of a hardware configuration of an example device that may function as a process control device/logic controller, such as the PCB and/or processor of a powered personal care (e.g., razor, toothbrush, water pick, etc.) device, and/or a charging device, among other devices. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

In one or more scenarios, a first PCB may comprise LED/light emitters 484 and/or light sensors 480, and/or camera 460, while a second PCB (not shown) may comprise the processor 410 and/or other circuit elements described herein. In one or more scenarios, a PCB may comprise some of all of the LED/light emitters 484 and/or light sensors 480, camera 460, processor(s) 410, and other circuit elements described herein.

The memory 420 can store information within the hardware configuration 400. The memory 420 can be a computer-readable medium (CRM), for example, a non-transitory CRM. The memory 420 can be a volatile memory unit, and/or can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks (not shown). The input/output device 400 may be in communication with one or more input/output modules (not shown) that may be proximate to the hardware configuration 400 and/or may be remote from the hardware configuration 400. The one or more output modules may provide input/output functionality in the digital signal form, discrete signal form, TTL form, analog signal form, serial communication protocol, fieldbus protocol communication and/or other open or proprietary communication protocol, and/or the like.

The camera device 460 may provide digital video input/output capability for the hardware configuration 400. The camera device 460 may communicate with any of the elements of the hardware configuration 400, perhaps for example via system bus 450. The camera device 460 may capture digital images and/or may scan images/light of various kinds, such as Universal Product Code (UPC) codes and/or Quick Response (QR) codes, reflected light from a target area, e.g., oral cavity, legs, arm pits, etc., and/or excited fluorescence light from a target area, e.g., oral cavity, legs, arm pits, etc., for example, among other images/light as described herein. In one or more scenarios, the camera device 460 may be the same and/or substantially similar to any of the other camera devices as may be described herein.

The camera device 460 may include at least one microphone device and/or at least one speaker device (not shown). The input/output of the camera device 460 may include audio signals/packets/components, perhaps for example separate/separable from, or in some (e.g., separable) combination with, the video signals/packets/components the camera device 460.

The camera device 460 may also detect the presence of one or more subjects that may be proximate to the camera device 460 and/or may be in the same general space (e.g., the same room, delimited area, etc.) as the camera device 460. The camera device 460 may gauge a general activity level (e.g., high activity, medium activity, and/or low activity) of one or more subjects that may be detected by the camera device 460. The camera device 460 may detect one or more general characteristics (e.g., height, body shape, skin color, pulse, heart rate, breathing count, etc.) of the one or more subjects detected by the camera device 460. The camera device 460 may be configured to recognize one or more specific subjects, for example.

The camera device 460 may be in wired and/or wireless communication with the hardware configuration 400. In one or more scenarios, the camera device 460 may be external to the hardware configuration 400. In one or more scenarios, the camera device 460 may be internal to the hardware configuration 400.

While the inventions have been described with respect to specific examples including presently preferred modes of carrying out the inventions, those skilled in the art will appreciate that there are numerous variations and permutations of the herein described systems and techniques. It is to be understood that other embodiments may be utilized and structural and functional modifications may be made without departing from the scope of the present inventions. Thus, the spirit and scope of the inventions should be construed broadly as set forth in the appended claims.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium. C++, C#, and/or C, Python scripts and/or Zephyr RTOS may be used.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or might not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While operations may be depicted in the drawings in an order, this should not be understood as requiring that such operations be performed in the particular order shown and/or in sequential order, and/or that all illustrated operations be performed, to achieve useful outcomes. The described program components and/or systems can generally be integrated together in a single software product and/or packaged into multiple software products.

Examples of the subject matter described in this specification have been described. The actions recited in the claims can be performed in a different order and still achieve useful outcomes, unless expressly noted otherwise. For example, the processes depicted in the accompanying figures do not require the particular order shown, and/or sequential order, to achieve useful outcomes. Multitasking and parallel processing may be advantageous in one or more scenarios.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A powered personal care system, comprising:
a battery-powered oral care device, comprising:
a handle portion, comprising:
a rechargeable battery, the rechargeable battery configured to be detachably connected to the handle portion; and
a motor, the motor configured to be energized by the rechargeable battery;
a head portion, comprising:
a plurality of brush bristles; and
a hydraulically powered battery charging device, comprising:
a housing;
a hydraulic inlet port disposed in the housing, the hydraulic inlet port configured to be connected to a hydraulic fluid source;
a magnetic core disposed within the housing;
at least one turbine blade in mechanical communication with the magnetic core such that a rotation of the at least one turbine blade causes a rotation of the magnetic core, the at least one turbine blade configured to be motivated into rotation by a flow of the hydraulic fluid across the at least one turbine blade; and
a battery port configured to insertably receive the rechargeable battery.

2. The system of claim 1, wherein the at least one turbine blade is a first turbine blade, the charging device further comprising:
a second turbine blade, the second turbine blade disposed opposite the first turbine blade, the second turbine blade in mechanical communication with the magnetic core such that a rotation of the second turbine blade causes a rotation of the magnetic core, the second turbine blade configured to be motivated into rotation by the flow of the hydraulic fluid across the second turbine blade, wherein the rotation of the magnetic core creates a magnetic field.

3. The system of claim 2, wherein the charging device further comprises:
a charging printed circuit board (PCB) disposed in the housing, the charging PCB configured to convert the magnetic field into a current.

4. The system of claim 3, wherein the charging device further comprises an electromagnetic induction coil configured to convert the current into a magnetic charging field, the magnetic charging field configured to magnetically charge the rechargeable battery in the battery port, and wherein the charging device is further configured to electrically charge the rechargeable battery via the current.

5. The system of claim 2, wherein the housing further comprises a top surface and a bottom surface, and the charging device is further configured such that the hydraulic inlet port is disposed in at least one of: the top surface, or the bottom surface, the charging device further comprising: a hydraulic outlet port disposed opposite of the hydraulic inlet port in at least one of: the top surface, or the bottom surface, the outlet port configured to be connected to a hydraulic discharge channel.

6. The system of claim 5, wherein the charging device is further configured such that the hydraulic inlet port is connected to a water supply line in a residential bathroom shower hydraulic circuit, and the hydraulic outlet port is connected to a residential bathroom shower nozzle.

7. The system of claim 6, wherein the charging device is further configured such that an activation of the residential bathroom shower hydraulic circuit motivates water to flow:
into the hydraulic inlet port;
across at least one of: the first turbine blade, or the second turbine blade; and
out of the hydraulic outlet port.

8. The system of claim 7, wherein the charging device is further configured such that the activation of the residential bathroom shower hydraulic circuit motivates water to flow through the residential bathroom shower nozzle.

9. The system of claim 1, wherein the oral care device is further configured such that the head portion is removably connected to the handle portion in at least two states: a decoupled state in which the head portion is separated from the handle portion, and a coupled state in which the head portion is connected to the handle portion.

10. The system of claim 9, wherein the oral care device further comprises a motor shaft, and the motor is configured to provide at least some amount of oscillation energy via the motor shaft to the head portion in the coupled state, and the oscillation energy places the plurality of brush bristles into a condition of at least one of: vibrational motion, or rotational motion.

11. The system of claim 1, wherein the rechargeable battery is further configured as a base of the oral care device.

12. The system of claim 3, wherein the charging device further comprises:
a magnetic wheel disposed in the housing, the magnetic wheel being in magnetic communication with the magnetic core, the magnetic wheel configured such that the rotation of the magnetic core causes a rotation of the magnetic wheel, the charging device further configured such that an effect of the rotation of the magnetic wheel on the charging (PCB) generates the current.

13. The system of claim 1, wherein the charging device further comprises a push lock/release mechanism disposed in the housing coaxially with the battery port, the push lock/release mechanism configured to at least one of: secure the rechargeable battery upon the rechargeable battery insertion into the battery port, release the rechargeable battery upon the rechargeable battery removal from the battery port.

14. The system of claim 1, wherein the rechargeable battery comprises a light emitting diode (LED) indicator, the LED indicator configured to:
indicate a charged state of the rechargeable battery via a first color of light emitted by the LED indicator; and
indicate a less-than-full charged state of the rechargeable battery via a second color of light emitted by the LED indicator.

15. The system of claim 2, wherein the charging device is further configured such that the first turbine blade, the second turbine blade, and the magnetic core are disposed in a coaxial arrangement.

16. The system of claim 1, wherein the housing further comprises a front surface and a rear surface, and the charging device is further configured such that the battery port is disposed in the front surface, wherein the charging device is further configured such that an optical panel is disposed in the front surface of the housing, the optical panel configured to provide at least some visibility of at least one of: the first turbine blade, the second turbine blade, or the magnetic core.

17. The system of claim 13, wherein the charging device is further configured such that the push lock/release mechanism further comprises a lock fitting disposed proximate to a rear of the battery port, the lock fitting configured to secure the rechargeable battery upon the rechargeable battery insertion into the battery port.

18. The system of claim 5, wherein the charging device is further configured such that the hydraulic inlet port is threadedly connected to the hydraulic fluid source, and the hydraulic outlet port is threadedly connected to the hydraulic discharge channel.

19. The system of claim 1, wherein the oral care device is further configured such that the rechargeable battery is threadedly connected to the handle portion.

20. A method performed using a powered personal care system, the system comprising:
a battery-powered oral care device, comprising:
a handle portion, comprising:
a rechargeable battery, the rechargeable battery configured to be detachably connected to the handle portion; and
a motor, the motor configured to be energized by the rechargeable battery;
a head portion, comprising:
a plurality of brush bristles; and
a hydraulically powered battery charging device, comprising:
a housing;
a hydraulic inlet port disposed in the housing, the inlet port configured to be connected to a water supply line in a residential bathroom shower hydraulic circuit;
a magnetic core disposed within the housing;
at least one turbine blade in mechanical communication with the magnetic core such that a rotation of the at least one turbine blade causes a rotation of the magnetic core, the at least one turbine blade configured to be motivated into rotation by a flow of the hydraulic fluid across the at least one turbine blade; and
a battery port configured to insertably receive the rechargeable battery, the method comprising:
detaching the rechargeable battery from the handle portion;
inserting the rechargeable battery into the battery port;
activating the residential bathroom shower hydraulic circuit;
charging the rechargeable battery;
removing the rechargeable battery from the battery port; and
attaching the rechargeable battery to the handle portion.
